(19) United States
(12) Patent Application Publication
(10) Pub. No.: US 2005/0018574 A1
(43) Pub. Date: Jan. 27, 2005

(54) Hybrid optical storage media and methods of use

(76) Inventors: Jens C. Jenkins, Salt Lake City, UT (US); Taylor B. Anderson, Gilbert, AZ (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/895,734

(22) Filed: Jul. 21, 2004

Related U.S. Application Data
(60) Provisional application No. 60/490,048, filed on Jul. 25, 2003.

(51) Int. Cl. G11B 7/24

(52) U.S. Cl. 369/53.21; 369/275.3

(57) ABSTRACT

Hybrid optical storage media enable various combinations of read-only, write and read/write functionality. The hybrid optical storage media can include, for example, read-only or write data portions, referred to as restricted data portions, as well as unrestricted read/write data portions. Primary data, such as multimedia, software applications and templates are written to the restricted data portions in an intended state of preservation and secondary data, such as advertisements, saved games, updates, form data and security information, are written to the unrestricted data portions in a state that allows them to be erased and/or overwritten without undesirably affecting the primary data. In some instances, the secondary data controls access to and use of the primary data. Coloring schemes can also be used to distinguish between different types of data portions and portions of disks that have been written to.

### CROSS-REFERENCE TO RELATED APPLICATIONS

The present application claims the benefit of U.S. Provisional Patent Application, entitled COMBINATION STORAGE MEDIA, Ser. No. 60/490,048, filed Jul. 25, 2003, which is incorporated herein by reference in its entirety.

### BACKGROUND OF THE INVENTION

1. The Field of the Invention

The present invention is directed to computer-readable storage media and, more particularly, to hybrid optical storage media and corresponding methods of use that physically and functionally combine the attributes of read-only, write and read/write optical storage disks.

2. Background and Relevant Art

It is common in the computer and entertainment industries to record programming applications, multimedia and other data in electronic formats to facilitate the reproduction and dissemination of the data in fast, consistent and high quality processes, while at the same time reducing the burden that is required to preserve the data.

There are various types of storage media that can be used to record data in electronic formats. These include, but are not limited to, magnetic storage media, solid-state memory, and optical storage media. Examples of magnetic storage media include floppy disks, tapes and memory cards. Examples of solid-state memory include variations of flash memory, such as CompactFlash and SmartMedia. Examples of optical storage media include Compact Disks (CDs) and Digital Video Disks (DVDs).

Each of the foregoing storage media has particular advantages and disadvantages. While magnetic disks typically provide a versatile and low cost storage option, optical disks typically provide longer preservation states. Solid-state memory, which is also versatile, is typically more expensive than magnetic disks, but is also more compact. Optical storage media, on the other hand, is typically less expensive than both magnetic storage and solid-state memory and also boasts a greater storage capacity.

Accordingly, although there is a place and demand for all types of storage media, optical storage media is often preferred in the software and entertainment industries because of the superior storage capacity and preservation states they provide. Optical storage media, which includes various commercial embodiments, is also becoming increasingly versatile and popular among consumers for personal use. The cost of both writable optical drives and writeable optical media has also fallen to within the reach of the average consumer user.

There are three basic categories of optical disks. The first, which is referred to herein as “read-only,” is configured to allow data to be read from the disk, but does not allow data to be written to the disk. The second type of optical disk, referred to herein as “write” disks, are configured to allow data to be written to the disks, but only a single time. Write disks essentially become read-only after they have been written to. It should be appreciated, however, that not all read-only disks were previous embodied as traditional write disks. For example, some read-only disks can be manufactured, through stamping and micro-deposition processes in such a way that they are never configured to be written to in the traditional sense. The last type of optical disk, which is referred to herein as “read/write” or “rewrite,” is configured so as to enable data written to the disk to be later overwritten and/or erased.

Each of the different optical disks has particular advantages. Read-only disks, for example, are practical in the software and entertainment industry to prevent recorded multimedia from being inadvertently or maliciously overwritten. Read-only disks can also be manufactured relatively inexpensively as compared to corresponding read/write and write disks. For example, some read-only disks can be manufactured through relatively inexpensive stamping procedures without requiring the application of thermo-sensitive dyes, photo-sensitive dyes, and dielectric layers which are typically required for the manufacture of the other disk types.

Read/write disks, on the other hand, are somewhat more versatile than read-only disks because they enable a user to incrementally record data to the same disk over many sessions or to erase and rewrite undesirable data with new data. It will also be appreciated that by reusing a rewrite disk, the overall cost per use of the disk is reduced.

Write disks are also becoming popular for personal use as they are becoming increasingly less expensive and as consumers are becoming more sophisticated with the technology. Some software applications have also been developed to increase the available options for recording to a write disk and for generally improving the user experience. For example, it is now possible to write data to a write disk in discrete recording sessions, thereby providing some of the versatility previously realized by only read/write disks. However, the ability to record data to a write disk in multiple discrete sessions is an implementation that requires the presence of special software to identify and index the different sessions properly.

Accordingly, despite the advances that have been made in the art, there are still many circumstances in which it is impractical to record data to the existing forms of read-only, write and read/write disks, as can be inferred from the following examples.

In the entertainment industry, for instance, read-only disks are typically used to record video and audio entertainment, thereby protecting the multimedia from being inadvertently or maliciously overwritten. However, writing multimedia to read-only or write disks can also create some undesirable consequences. For example, video programming is typically supplemented with time-sensitive advertising for future events, such as upcoming television programming, soon to be released movie titles, campaign notices, as so forth, which are only relevant for a limited period of time. After the advertised event has passed, the corresponding advertisements become obsolete. Nevertheless, because the advertisements are recorded in a read-only format, the advertisements will remain,; wasting precious space on the storage media. The obsolete advertisements will also be replayed over and over again, for the life of the storage media, to the consternation of many-a-viewers.

The same is also true for other types of advertisements that are more general in nature, even when they are not as time sensitive. In particular, general advertisements can also become dated and somewhat obsolete and ineffective after an extended period of time. It is common, for example, to find movies that are available for rent, sale and library check out that contain dated, obsolete and essentially ineffective advertisements. Again, however, because the advertisements are often recorded in a read-only format, they cannot be replaced without replacing the entire disk containing the advertisement.

Another problem with recording multimedia to a read-only format is the restriction this places on the ability of the consumer to control the viewing of the multimedia in a customized and desired manner. For example, some consumers may not want their children to watch extremely violent or sexually explicit content that they might consider offensive. However, the consumer is limited in their ability to control or censor the content of the multimedia for their children, unless they are present when the multimedia is being viewed. To overcome this limitation and to increase the extensibility of the multimedia, some programming is recorded in different versions based on rating content, extended features, and other criteria. For example, a movie might include ‘unedited,’ ‘R-rated,’ ‘PG-rated’ and other versions of the media that are available on the same disk. This solution, however, is still limited insofar as the parent cannot necessarily restrict the selection that will be made by their children, unless they are present. Furthermore, even if the parent is present, they might not necessarily find that the edited versions that are available coincide with their own editing preferences.

Additionally, even if consumers were able to somehow identify and record customized edits of the multimedia through some software residing at the media player, the effectiveness of such a solution is restricted to the capabilities of the player that would presumably track and store the edits. Accordingly, even if the customized edits could be recorded at the player, rather than on the multimedia disk itself, then the edits could not be applied when the disk was played with a different player.

Software distribution illustrates another example of storage media deficiencies. As with the entertainment industry, general software applications are typically sold in a read-only format to reduce the risks of the data being inadvertently overwritten, as well as to reduce the manufacturing and distribution costs, as generally described above.

Unlike the entertainment industry, however, many general purpose software applications are sold to the public before they reach their ultimate and final working conditions. Accordingly, patches, drivers and other updates are commonly downloaded and installed onto a consumer's computer, after the consumer has already purchased the corresponding software, and sometimes from third party sources, to improve or otherwise enhance the capabilities of the software and the user experience.

Unfortunately, when the software products need to be reinstalled or loaded onto a new computer, for example, the consumer typically has to find, download and install each of the updates all over again. In similar circumstances, when consumers reformat their computers they often have to reinstall the installation disk(s) that were provided with the computer. However, because updates that are downloaded to the computer, subsequent to the initial installation, are not updated to the installation disk(s), the consumer may have to redundantly locate and install each of the updates that were saved to the computer subsequent to the purchase date each time the system is reinstalled. This can be very time consuming and frustrating, particularly when the updates cannot be located and have to be re-downloaded from the manufacturer or downloaded from unpredictable third party Internet websites.

A major cause for some of the foregoing software problems is that software applications are often recorded and sold on read-only storage media, thereby preventing the consumers from recording updates to the corresponding application software. Accordingly, either the consumer has to record updates to separate storage media, thereby incurring additional costs and maintenance, or else the consumer has to redundantly find and download the updates each time the corresponding software has to be reloaded.

Limitations of read-only disks are also prevalent in the gaming industry, where most computer games are recorded in a read-only format. In particular, read-only disks effectively prevent gamers from saving instances of their played games to the same storage media that contain the game application. Accordingly, gamers have to utilize additional storage media such as the console hard drive, separate memory cards or other devices to record snapshots and instances of a played game.

One problem with saving games to the console, however, is that it decreases the portability of the game while it is being played. In particular, it is not very convenient to transport a game console from one location to another, at least as compared to transporting an optical disk. In consideration of the total amount of time it can take to play some games, and during which time the player may wish to play the game at various venues (e.g., friends' houses), this can be particularly inconvenient.

Saving game instances to secondary storage media, other than the console, can also create problems because the additional storage media has to be purchased and can thereby increase the overall cost of playing the game. There is also a chance that the secondary storage media will get lost or otherwise become separated from the original game media because the new storage media will most likely be marked and packaged differently than the original game media. Additionally, some consoles do not provide a convenient mechanism for transferring saved games using secondary media.

Other situations in which it is not practical to record data to read-only or read/write media includes the storage of data comprising a combination of both fixed and dynamic data. For example, with collaborative works, a first grouping of data may represent a project that is to remain in a fixed form for evaluation or to be otherwise enhanced with dynamic secondary data. Likewise, with certain forms, it may be desirable to maintain a template in a fixed form, while accepting new data entries to complete the form, as in the case of contact databases or financial analyses. Applications like these using data that is both inherently dynamic and critical could benefit greatly from the ability to store data concurrently with the underlying application.

Some data files are inherently dependent on a specific version or installation of a piece of software. Every year, millions of United States citizens use commercial tax preparation software to prepare their income tax returns. As the return is created, data files specific to the tax laws and tax software version for a specific tax year are created. These data files contain critical financial data, but are only useful and generally only accessible from the context of the installed software specific to the tax year for which the returns were prepared. Compounding the problem is the fact that in the process of using the tax preparation software, the user commonly uses an internet connection to automatically check the manufacturer's website for state-specific income tax software and/or last-minute updates to the federal tax software before or while preparing the tax return. When such software updates are downloaded, they create an instance of the tax preparation software that is different than the original software on the installation media. If the user is to adequately archive the data and method for preparing income tax returns, then the user must archive not just the data files, but the original installation media and any applicable update patches. Users of software of this type could benefit greatly from the ability to add the software updates, necessary data files, and possibly a more easily accessed version of the resultant tax returns (in PDF format or as image files) to the original installation media for archival purposes.

Similarly, in the education industry, it would be useful to write text, administer tests, and provide other education materials in a fixed format, while dynamically enabling collaboration and input to be recorded to the same media that contains the static data. In these instances, however, existing storage media is not physically configured to enable secondary data to be written or altered on the same disk that contains the primary data in a preserved and fixed or static state that cannot be altered or overwritten, such as when data is written to a read-only media. Instead, to prevent secondary or supplemental data from undesirably altering primary data, either the data groupings have to be stored on entirely separate storage media and/or the primary data has to be protected through some sort of special software application (e.g., read-only attribute designations, password access restrictions, etc.). Attribute and password barriers, however, can be changed or breached because they are based on inherently vulnerable software architectures rather than on hardware. Software solutions to such problems are also inherently vulnerable to virus and other software attacks.

The educational process lends itself to a situation where all three storage methods (static, one-time writeable, and re-writeable media) could be useful in a single piece of storage media. Reference material could be permanently recorded to the static storage area of the media, temporary storage of dynamic assignments and works-in-progress could be stored to the re-writeable portion of the media, and online tests, quizzes, and scores that should not be altered once recorded could utilize a one-time, more permanent writeable portion of the media.

Yet another problem with existing read-only storage media is that certain software executables are prevented from being stored and implemented entirely within the original media that contain the software applications. For example, existing limited use application disks that are configured to be used only a limited number of times or for a limited period of time rely on the memory of a processor or a remote storage media to keep track of how many times the software has been used. This, however, can be somewhat unreliable and difficult to track, particularly when the software is used at different instances on different computing systems, and/or when a user is knowledgeable in local storage techniques. The problem involving installation of single-system software on multiple systems is even harder to track, and almost impossible to prevent if computers are not networked together and accessible for remote inspection via that network. Systems that track incremental use at remote servers also necessitate reliable network connections and accessibility.

Other limited use storage media are manufactured with time-sensitive materials that degrade and thereby become inoperable after a certain period of time. Such solutions, however, do not permit true limited-use restrictions (e.g., allowing a predetermined number of uses), but instead restrict use solely upon the passage of time and environmental conditions.

The nature of existing optical storage media has also prevented the commercialization of a disk that can protect and regulate use in a customized manner for personal and business use, without third party intervention involving remote authentication, authorization and verification. In particular, existing disks do not enable passwords or other security characteristics to be customized and modified and applied directly to the disks themselves. Instead, security access is limited by the specific software files and corresponding security attributes for each of the files that are stored on the disks. Alternatively, security and access to the disk is based on predetermined authentication, authorization and verification from remote computing objects, devices, or third parties that are remote or separate from the disks and that is predetermined before the disks are even made available to the public. This is particularly true when the disks are created as read-only or write disks.

Accordingly, for at least the foregoing reasons, it is evident that there is a need in the art for improved storage media, particularly optical storage media, and corresponding methods of use.

### BRIEF SUMMARY OF THE INVENTION

The present invention is directed at hybrid optical storage media and corresponding methods of use that physically and functionally combine the attributes of read-only, write and read/write optical storage disks.

In one embodiment, the improved and hybrid storage media includes an optical disk having a combination of read-only, write and read/write data portions. Data written to read-only and write data portions cannot be overwritten, whereas data written to read/write data portions can be overwritten. In certain embodiments, each of the different data portions has an index located within the corresponding data portion. Each of the different data portions can also be indexed in a master index located within a predetermined location.

One method for using the improved storage media includes permanently recording a desired multimedia program to a restricted write or read-only data portion and recording supplemental information such as advertising to an unrestricted read/write data portion. At a later time, the advertising or other supplemental information is replaced with new or modified supplemental information and without undesirably affecting the multimedia programming that is recorded to the read-only data portion. Whenever data is written or modified in a particular data portion, the index corresponding to that data portion can be updated to reflect the current state of the data portion.

In another embodiment, a game is recorded to the restricted data portion, while the unrestricted data portion is reserved as supplemental storage space for storing game software updates and/or played game instances. Software applications, such as those that provide templates, can also be recorded to read-only data portions, while preserving the unrestricted data portions for supplemental information that is used to fill out the forms defined by the templates. This method can also be applied to the creation of collaborative works and education and testing materials, by recording projects and other desired material to the restricted write or read-only data portions, and while enabling input and feedback to be written to the unrestricted read/write data portions at a later time, and without creating a risk that the primary data will be overwritten.

The inventive storage media can also be used to consolidate the functionality and utility of software executables. For example, the use of an application which is written to restricted write and read-only media can be tracked and recorded within the unrestricted read/write data portions of the same media, along with corresponding tokens or keys that enable or disable the use for the application based on any time or use restriction. In particular, after the application has been used a predetermined number of times or for a predetermined duration, the enabling tokens or keys can then be overwritten to prevent further use. Then, at a later time, the use limits can again be reset by downloading enabling software to the read/write data portion, such as, for example, upon paying for additional use or renewing a subscription. To help prevent unauthorized use, the computing modules enforcing the methods can be written to restricted read-only data portions of the disk, such that they cannot be modified.

In yet another embodiment, a software application is written to restricted write or read-only data portions of a disk while unrestricted write or read/write data portions are reserved for subsequent patches, drivers, and other updates that correspond to the software application. Accordingly, when the software application needs to be reinstalled or loaded to a new computing device, the software application and corresponding updates can be contemporaneously loaded from the hybrid storage media in a complete and updated format. This method can also be applied to storage media containing multiple applications/updates, including, but not limited to computing system re-initialization software.

In a similar embodiment, an original collection of multiple device drivers for a computing system could be delivered on the read-only data portion of the storage media along with an automated mechanism for the retrieval of updates to the desired device drivers. Subsequent updates could be retrieved on demand and stored in the re-writeable portion of the original installation media. Such a disk might be delivered with every new computing system, and periodically updated by the owner as a preventative backup measure.

In yet another embodiment, storage media can be configured to perform self-authentication, verification and authorization for restricting access to read-only or read/write data stored on the disk. In particular, the disk can contain at least one restricted read-only data portion having software executables that request a password or other security information that can be subsequently used to authenticate or authorize the use of the disk. When the security information is provided, it can be written to another restricted use write data portion, and such that all subsequent use of the disk can be predicated upon requesting and receiving matching security information. In this manner even data written to unrestricted read/write data portions can be protected by the hardware configuration of the disk. In other embodiments, self-authentication information can also be written to unrestricted data portions, to be modified by the user as desired.

In yet other embodiments, the hybrid disk can include multiple restricted use portions that are physically separate and partitioned on the same side of a disk, such that specialized software is not required to index and track multiple recording sessions of data on a single write only disk. Instead, a user can simply designate which of the different predefined disk portions to write data to, each of which can be indexed separately within their corresponding physical portions. It should be appreciated that in this way, a user can more easily utilize the entire storage capacity provided by a disk.

To distinguish between the different data portions and/or to indicate which portions of a disk have been written to, various color schemes can be employed and dynamically altered during use of the disk.

It should also be appreciated from reading this application that the inventive optical media of the present invention provides a hardware solution for many traditional software problems, including, but not limited to those described herein.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an optical disk that includes two or three discrete data portions, one that allows read/write capabilities, one that allows one-time writing of data, and one that stores read-only data.

FIG. 2 illustrates a cross-sectional side view of one embodiment of a restricted use read-only data portion that can be included within embodiments of the combination storage media of the invention.

FIG. 3 illustrates a cross-sectional side view of one embodiment of a restricted use write data portion that can be included within embodiments of the combination storage media of the invention.

FIG. 4 illustrates a cross-sectional side view of one embodiment of an unrestricted use read/write data portion that can be included within embodiments of the combination storage media of the invention.

FIG. 5 illustrates a flowchart of one method for using a combination storage media to store a preserved state of primary data within restricted use data portions of the storage media and in which unrestricted data portions of the storage media are reserved for writing and rewriting secondary data to the storage media.

FIG. 6 illustrates a flowchart of one method for using a combination storage media to store a preserved state of primary data within a first restricted use data portion of the storage media and in which secondary data is written to a second restricted use data portion of the storage media in a preserved state, wherein the second restricted data portion comprises a different physical structure than the physical structure of the first restricted data portion.

FIG. 7 illustrates a block diagram of one computing environment in which certain methods of the invention may be practiced.

### DETAILED DESCRIPTION OF THE PREFERRED EMBODIMENTS

The present invention is generally directed to optical storage media having at least two different physical formats and that are physically separated by one or more physical partitions, each of which can have its own index. In one embodiment, a first physical format enables unrestricted read/write functionality, namely, writing and overwriting, while a second physical format is restricted inasmuch as it does not allow read/write functionality.

Although embodiments of the invention are described in reference to optical disks, the scope of the invention also extends to other storage media that are not considered traditional optical disks as well, such as, but not limited to gallium ion disks (HD-disks) and other types of disks that can store data that can be read through the use of light, X-rays, and other particles that are applied to such disks.

Even more broadly, the scope of the invention also extends to other types of storage media, including other media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, solid state memory, or any other medium which can be used to carry or store desired program code means in the form of computer-executable instructions or data structures and which can be accessed by a general purpose or special purpose computer.

Embodiments of the invention are also directed to methods for using the hybrid storage media. For example, methods for using the hybrid storage media include embodiments in which primary data is written, in an intended state of preservation, to restricted use data portions of the storage media, and in which secondary data is written and/or rewritten to unrestricted data portions of the storage media, and without undesirably affecting the storage or use of the primary data. In other embodiments, the secondary data can also control or limit access to the primary data. In yet additional embodiments, the secondary data is a derivative of the primary data, or is specifically related to the primary data.

The methods of the invention can be implemented with the use of special purpose and general-purpose computing devices, as discussed in greater detail below. The hybrid storage media and computing devices can carry or utilize any combination of computer-executable instructions for implementing the methods of the invention. Computer-executable instructions generally comprise instructions and data which cause a general purpose computer, special purpose computer, or special purpose processing device to perform a certain function or group of functions, such as identified by the acts and steps that are recited herein.

Certain definitions will now be provided to clarify the intended scope of the invention, as described herein.

The term “hybrid storage media” and “combination storage media,” as used interchangeably herein, generally refer to storage media that have at least two physically different data portions, having different physical properties, and that are integrated and consolidated into a single portable object, such as, but not limited to disks (e.g., optical disks), card devices (e.g., USB memory card devices), mini-disks (e.g., mp3, mp4, and so forth), and other such devices. In one exception, the hybrid storage media can also comprise an optical disk containing a plurality of physically similar but separated or segmented data portions that are present on a single side of the disk, wherein each of the separated data portions contain their own index disposed within each of the corresponding data portions.

Some examples of the hybrid storage media according to the invention include optical storage media having a combination of (a) read-only and rewrite data portions, (b) write and rewrite data portions, (c) read-only and write data portions, (d) at least two write data portions, and (e) read-only, write and rewrite data portions.

The various types of data portions, referred to above, have generally been categorized into one of two groups by this application. The first group, corresponding with the interchangeable terms “restricted” and “restricted use,” includes write and read-only data portions in which each discrete part of the restricted portion can only have data operably written thereto a single time, thereby preventing the data from being overwritten. The second group, corresponding with the interchangeable terms “unrestricted” and “unrestricted use,” includes read/write data portions that can be written, rewritten and erased or ‘cleaned’ for reuse.

The term “data portions” in a more generic sense generally refers to segments or parts of the storage media having suitable physical properties to enable data to be recorded thereto. These physical properties can include structural, chemical and magnetic properties. The formats of the data portions can include optical disk formats, such as CD and DVD formats, of which there are many, solid state formats that operate through phase-shifting, magnetic disk formats, and combinations thereof. In certain embodiments corresponding to optical disks, the different data portions are manufactured to the same side of the disk. Although it will also be appreciated that the different data portions can also be written to both sides of a disk.

The term “primary data,” is generally referred to herein as data that is written to restricted use data portions of the storage media in an intended state of preservation. However, there are also certain circumstances in which primary data is written to unrestricted use data portions of the storage media.

Non-limiting examples of primary data include multimedia data (text, audio, images, video, and so forth), software applications (games, utilities, security applications, executables, and so forth), templates, form data and database data, educational materials (projects, papers, testing materials, lectures, and so forth), security data, limited use data, and miscellaneous other data that a consumer may wish to store at any given time.

The term “secondary data” is generally referred to in some embodiments as data that is stored in the unrestricted (read/write) data portions of the inventive storage media. However, as described below, secondary data can also be stored in restricted use data portions (read-only or write) that are different than restricted use data portions that contain the primary data.

Secondary data typically, although not necessarily corresponds to the primary data, although not necessarily a derivative or supporting file. For example, secondary data can include advertisements, instances of played games, updates (e.g., patches, drivers, and so forth), limited use and tracking information (e.g., counters, tokens, application enabling objects, and so forth), data for filling in forms and templates, security information (e.g., for authentication, authorization and verification), collaboration and general input corresponding to projects, educational materials and other primary data. The terms “supplemental information” and “enhancement data” are also used at times herein to refer to secondary data.

It will be appreciated by those of skill in the art that the PCA (Power Calibration Area) and PMA (Program Memory Area) data and other standard data that is typically included in optical disks can also be included within the definitions of primary and secondary data. Accordingly, the PCA, PMA and other elements (lead-in and lead-out) data/silence can also be included in either the restricted use or unrestricted use portions of the disk, or redundantly in multiple portions, to accommodate different configurations and needs.

In many embodiments, the term “index” (referred to above as corresponding to the different data portions) includes the PCA and PMA. Accordingly, the inventive disk may actually include multiple PCA and/or PMA data sections, one for each data portion. In some embodiments, a master PCA and PMA data section can also be provided to index each of the different data portions. If each of the data portions have their own PCA and/or PMA data, the master PCA and PMA data can reference the discrete PCA and PMA data sections.

Although application of certain methods described herein are somewhat limited by the durability and storage capacity of the storage media, as well as the sophistication of existing media readers, it is expected that both the durability and storage capacities of existing storage media, and the sophistication of media readers, particularly in the optical disk industry will continue to improve, such that each of the following methods will be both practical and economical in coming years, if not sooner.

Hybrid Combination Storage Media

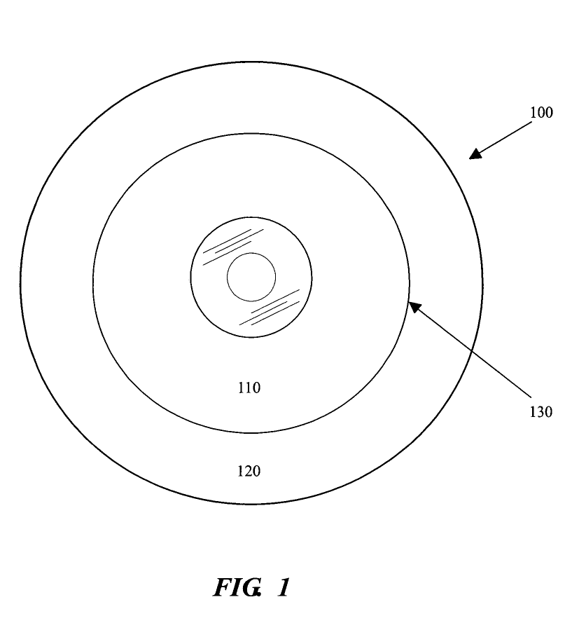

Attention is now directed to FIG. 1, which illustrates one embodiment of a storage media comprising an optical disk 100. The optical disk 100 includes a restricted use data portion 110 as well as an unrestricted use data portion 120. Both the data portions 110 and 120 are configured to store data. However, data can only be written a single time to the read-only data portion 110, whereas data can be written and overwritten multiple times to the read/write data portion 120.

In the present embodiment, the data portions 110 and 120 are shown to be bifurcated into separate and discrete portions of the disk 100. The data portions 110 and 120 are also shown to comprise substantially equal proportions of the disk 100. It will be appreciated, however, that in other embodiments, the data portions 110 and 120 can also comprise unequal portions of the disk 100 and can also be interspersed and/or segmented throughout areas of the disk 100. Any number of portions can also exist on a single disk. For example, although only two different portions are shown, the disk can also include more than two data portions.

In some embodiments, the distinct data portions 110 and 120 are also disposed on a single side of the disk 100, as shown, although this should not be construed as a constraint or limitation of the invention. Instead, the invention also extends to embodiments in which the disk 100 comprises a two-sided disk and in which the data portions 110 and 120 coexist on the same side(s) or on different side(s) of the disk 100. Similarly, the invention also extends to embodiments in which the disk includes multiple overlapping layers of data, such as, but not limited to DVD formats, and wherein portions of the data portions 110 and 120 overlap.

In yet another embodiment, the disk 100 can also comprise two different types of restricted use portions. For example, the disk can contain a first restricted use portion manufactured as a read-only data portion and a second restricted use data portion manufactured as a write data portion.

In another embodiment, each of the restricted use data portions can also comprise physically separated segments on a single side of a disk that are physically configured to be written to at different times, without requiring special software. Accordingly, although not shown, each of the segments can include its own index, PCA (Power Calibration Area) and/or PMA (Program Memory Area). One benefit of such embodiments is that a user can incrementally record data to the disk, to utilize a greater capacity of the disk, and without requiring special software for enabling multi-session recording.

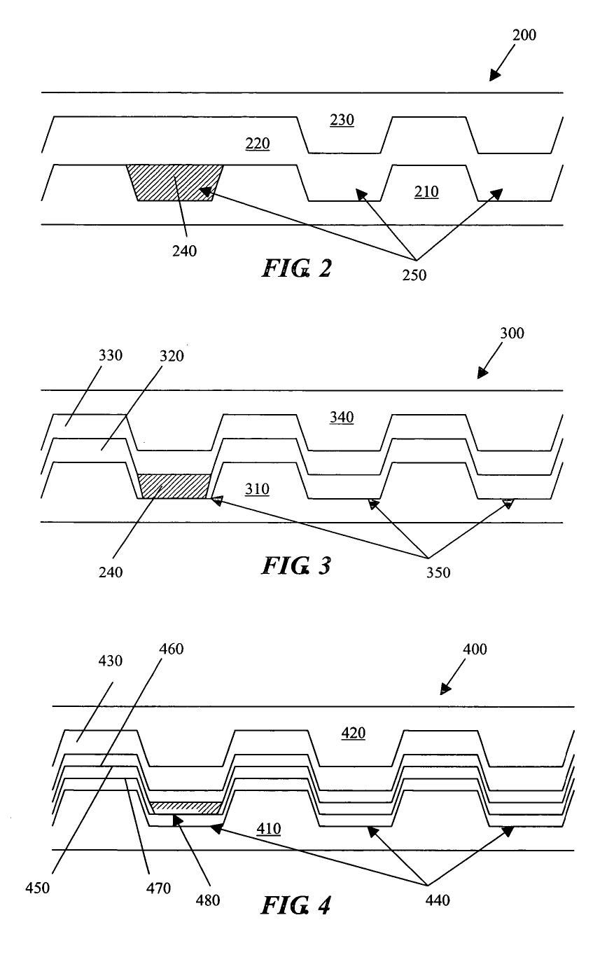

FIG. 2 illustrates a cross-sectional side view of one non-limiting example of a restricted use data portion comprising a read-only data portion 200 of an optical disk. As shown, the read-only data portion 200 includes a plurality of physical layers, including a base substrate layer 210, a reflective layer 220, and a protective layer 230.

The base substrate layer 210 is preferably manufactured out of a material that is transparent, such as, but not limited to a polycarbonate substrate, or another material through which a reading device can read or scan data structures. As with other base substrate layers of existing optical disks, the base substrate layer 210 also preferably includes small tracks 240 that circumferentially extend around the center of the disk in a continuous and connected manner, which can be used as a guide for tracking during reading of the disk.

The reflective layer 220 can comprise any suitable reflective material. In one embodiment, the reflective coating comprises aluminum. However, it will be appreciated that other reflective coatings can also be used, including, but not limited to aluminum alloys, gold alloys, silver alloys and combinations thereof. The reflective layer 220 overlays the base substrate layer 210 and is configured to reflect light or other particles that have been directed at the base substrate layer 210 back to a reader.

Sequences of reflections are created when light or other particles bounce off of the reflective layer in patterns corresponding with structures, such as structure 240, which are formed on the disk. The data structures correspond directly to the digital data that is stored on the disk and can be interpreted by an appropriate disk drive by directing light to the reflective layer and interpreting the reflections made therefrom. The data structures can be formed on the disk in a variety of ways, including stamping, molding, deposition, and machining processes that can be performed to the base and/or reflective layers 210 and 220.

The protective layer 230 can comprise a layer of lacquer, acrylic or another material that is configured to prevent the reflective layer from becoming damaged. Although the protective layer 230 is shown as a single layer, it will be appreciated that other protective layers can also be added to enhance or improve the durability of the disk.

FIG. 3 illustrates a cross-sectional side view of one non-limiting example of a restricted use data portion comprising a write data portion 300 of an optical disk. As shown, the write data portion 300 also includes a plurality of physical layers, including a base substrate layer 310, a dye layer 320, a reflective layer 230, and a protective layer 240.

The base substrate layer 310, the reflective layer 330 and the protective layer 340 are similar to those of the read-only data portion 200, described above (e.g., 210, 220, 230). The write data portion 300 also includes tracks 350 that are similar to the tracks of the read-only data portion 200. However, unlike the read-only data portion 200, the write data portion 300 does not include preformed data structures from manufacturing processes. Instead, the data structures are formed into the dye layer 320 through or photo etching, as is well known in the art. In particular, when the dye is treated by a laser during a writing process, opaque data structures, such as dye structure 240, are formed in the disk that can later be distinguished and read by an appropriate reader, such as through a light reflecting process. The dye layer 232 preferably comprises a thermo-sensitive or photo-sensitive material, such as, but not limited to cyanine dyes and phthalocyanine dyes.

The write data portion 300 and the read-only data portion 200 are considered restricted use data portions because they cannot be rewritten once they have been written to. In contrast, the unrestricted read/write data portion 400, shown in FIG. 4 can be rewritten again and again, as described below.

The example of the read/write data portion 400 shown in FIG. 4 also includes a plurality of physical layers that include a base substrate layer 410, a reflective layer 430 and a protective layer 420, and which will not be described in detail because they are similar to the corresponding layers of the aforementioned restricted use data portions. The read/write data portion 400 also includes tracks 440 that are similar to the tracks 350 and 240 that have been described above.

Unlike the foregoing restricted use data portions 200 and 300, however, the read/write unrestricted data portion 400 includes a dye layer 450 that can undergo a phase-change and that is sandwiched between two dielectric layers 460 and 470.

In one embodiment, the dye comprises a crystalline compound composed of a silver, indium, antimony and tellurium mixture, although it will be appreciated that other compositions can also be used. The dye layer 450 is specifically configured to take a first form, such as a crystalline form, when it cools down from being heated to a first temperature and to take a second form, such as an amorphous form, when it cools down from being heated to a second temperature. Accordingly, appropriate light/heat can be applied to particular locations along the disk to form patterns of dye structures, such as, structure 480, which can be distinguished by a reader.

The dielectric layers 460 and 470 are configured to absorb any excess heat from the phase-change that occurs during the writing processes. A reader can read the data stored on the disk, which is represented by the pattern of amorphous and crystalline structures formed in the disk, because the amorphous structures reflect less light than the crystalline structures when they are exposed to light.

After writing to the read/write data portion 400, the disk can be purged or rewritten by heating the dye layer 450 to an appropriate temperature for a sufficient time until it returns to the crystal state.

Although specific examples of certain read-only, write and read/write data portions have been provided, it will be appreciated that the invention also extends to combination media storage comprising other types of restricted and unrestricted data portions that are formed from different physical structures and assembled layers. For example, DVD read-only, write, and read/write structures can include different types and quantities of dye layers and reflective layers.

Combination storage media according to the invention can also comprise DVD type formats that are used in combination with CD type formats. Solid state memory can also be written to the storage media and used in combination with optical storage media formats, wherein the solid state memory comprises unrestricted use portions, and wherein the optical storage media can be used as the restricted use portions. These examples, however, should also not be construed as limiting the scope of the invention. Instead, the scope of the invention broadly extends to all combination storage media that are self-contained and include both unrestricted data portions as well as restricted data portions. Diskettes and optical disks simply comprise one preferred embodiment of the invention.

Manufacturing of the combination storage media can be performed with various combinations of manufacturing processes and techniques to prevent cross-contamination of the various layers between the two types of data portions. For example, the restricted use and unrestricted use portions can be manufactured at separate times or with special dividers to be used during sputtering, through two color molding, through micro deposition, or any combination of the above. Dividers or divisions between the data portions can also remain within the storage media after manufacturing, such as ring 130 (FIG. 1) that physically separates the two data portions. When the data portions are disposed on opposite sides of the storage media, the base substrate layer can also operate as a barrier between the two data portions.

In other embodiments, the two or more data portions are manufactured separately, such as for example on different base layer substrates, and subsequently assembled together through chemical and/or mechanical bonding.

In certain embodiments it can be desirable to form the restricted use and unrestricted use data portions on the same side of the storage media and/or having the same basic formatting (e.g., DVD or CD) so that a single reader can be used to read the data contained thereon. However, it will be appreciated that the combination storage media can also contain different types of formats and be written on different portions of the same storage in such a manner that they require two or more readers to read the data contained thereon. This, however, should not be viewed as a negative limitation, particularly since storage reading drives are becoming more sophisticated and are often configured to read from different sides of a disk and to read different types of formatted disks.

Yet another division that can be utilized to separate data portions of the same and different types can include indexes, or elements thereof, as generally described above.

Some examples of the different types of hybrid storage media that can be manufactured according to the invention include the following: Optical disks having restricted and unrestricted data portions that are both configured with one or more DVD type formats; Optical disks having restricted and unrestricted data portions that are both configured with one or more CD type formats; Optical disks having a restricted data portion configured in a DVD type format and an unrestricted data portion configured in a CD type format; Optical disks having a restricted data portion configured in a CD type format and an unrestricted data portion configured in a DVD type format; Disks having a restricted data portion configured in an optical DVD type format and an unrestricted data portion comprising solid state memory; Disks having a restricted data portion configured in an optical CD type format and an unrestricted data portion comprising solid state memory; Disks having a restricted data portion configured in an optical DVD type format and an unrestricted data portion comprising magnetic memory; And disks having a restricted data portion configured in an optical CD type format and an unrestricted data portion comprising solid state memory.

The forgoing examples are provided as a matter of illustration and should not, therefore, be construed as limiting the scope of the invention. It should also be appreciated that the restricted and unrestricted portions can be disposed on the same side of the disk or on different sides of the same disk and that they may be configured to be read by the same or different readers, depending on their placement and the sophistication of the readers.

Certain methods for using the combination storage media of the invention will now be described. It will be appreciated, however, that the following methods of use are provided as a mere illustration as to the utility of the combination storage media and should not, therefore, be construed as limiting the scope of the invention.

Multimedia Applications

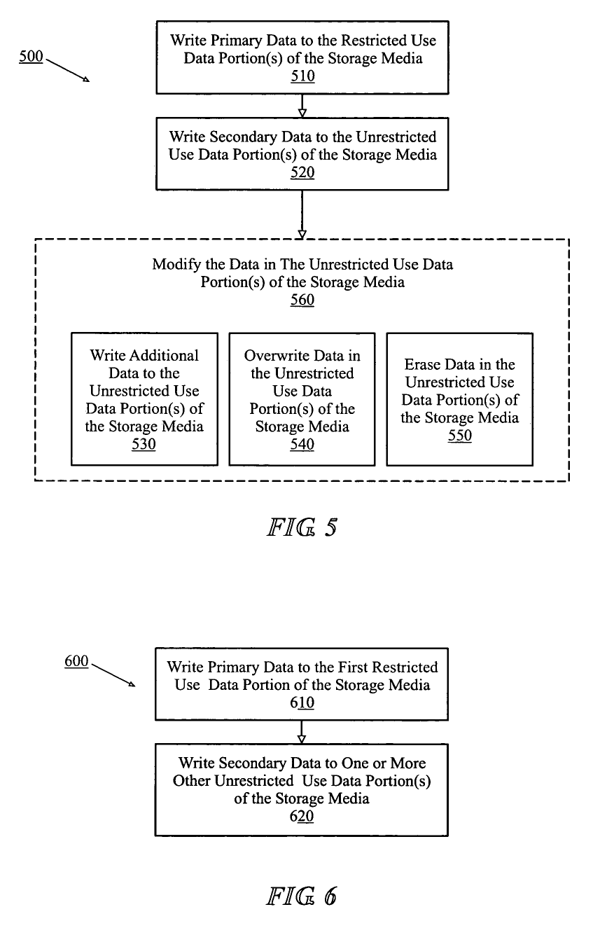

Several methods for using the inventive combination storage media will now be described with specific reference to the flow charts shown in FIGS. 5 and 6.

FIGS. 5 and 6 illustrate basic block diagram flowcharts of methods for using the inventive storage media. In FIG. 5, the illustrated method is directed to the use of combination storage media having a restricted use data portion as well as an unrestricted use data portion. The illustrated method shown in FIG. 6, on the other hand is directed to the use of combination storage media having two different restricted used data portions.

As shown in FIG. 5, the flowchart 500 illustrates a method that includes various acts, namely, an act of writing primary data to the restricted use portion(s) of the storage media (act 510), an act of writing secondary data to the unrestricted use portion(s) of the storage media (act 520), and acts of writing additional data to the unrestricted use data portion(s) (act 530), overwriting the data in the unrestricted use data portion(s) (act 540), and erasing data from the unrestricted use data portion(s), such as for example, in preparation for subsequent reuse (act 550).

As shown, acts 530, 540 and 550 generally correspond to the step for modifying the data in the unrestricted use data portion(s) of the storage media (step 560). Acts 530, 540 and 550 can be performed independently or jointly and contemporaneously. The step for modifying the data in the unrestricted use data portions(s) of the storage media (step 560) is preferably performed without undesirably affecting the primary data written to the restricted use data portion(s) of the storage media, as illustrated by the examples that are provided below.

It will be appreciated that the various acts 510, 520, 530, 540 and 550 can be performed at the same general time or at different times (e.g., prior to distribution for sale, after distribution for sale, or any combination thereof). Likewise, the various acts can be performed with a single computing device or with different computing devices that are either associated or disassociated.

The forgoing method and corresponding acts will now be described with specific reference to examples of using the inventive combination storage media having both at least one restricted use portion and at least one unrestricted use portion. In some of the following examples, certain acts from the method illustrated in FIG. 5 are not explicitly included. It should be appreciated, however, that the following examples can be modified to include any of the foregoing acts that are not explicitly recited in the examples.

### EXAMPLE 1

In a first example, an optical disk, such as a DVD style disk, includes both a restricted use data portion (e.g., read-only or write) and an unrestricted use data portion (e.g., read/write). A movie or other multimedia content is written to the restricted use data portion and advertising or other supplemental information is written to the unrestricted use data portion. A consumer buying or renting the movie can not tell a difference between this disk and other existing movie disks. At a later time, however, the advertising on the present disk can be replaced with new and current advertising.

New replacement advertising can be received, for example, by a movie rental business such as Blockbuster Video or Hollywood Video. They could then place their movie rental disks into a recording device that would overwrite the old advertisements with new advertisements received from an advertising source. In this manner, movies that are subsequently rented or purchased from the video stores can be distributed with new and effective advertising, rather than old, dated and obsolete advertisements. Furthermore, by enabling advertisements to be replaced in this manner, the market for advertising can become available for local advertisers that can not afford to advertise on a national or global scale. The television industry could also use this method to more effectively advertise upcoming television programming, without having to worry that the advertisement would only be relevant for a short period of time.

This method can also be applied in other ways. For example, libraries or other such institutions could generate advertisements to receive funding or they could promote community programs or disseminate other information by replacing the existing advertisements with new supplemental information.

In yet other embodiments, the consumer's home video equipment could receive updated advertisements or other supplemental information through a network connection, such as the Internet, through the VBI (vertical blanking interval) of television programming, or through unused bandwidth of a satellite transmission, which could be used to overwrite the existing secondary data that is stored on the unrestricted portions of the disk. In this embodiment, the new supplemental information could be recorded at a contemporaneous time in which the consumer watches the primary data on the disk. Of course, in such embodiments, it would be desirable for the consumer's video equipment to have recording capabilities.

In yet another embodiment, the secondary data can be overwritten with blank data or otherwise erased when the advertisements are no longer relevant so that the ultimate consumer does not have to be bothered with irrelevant advertisements.

It will be appreciated that when only selected material is overwritten or added to the unrestricted data portion of the storage media, the computing device being used to play the multimedia content can be used to cache all of the data from the unrestricted data portion and to rewrite the unrestricted data portion in the desired manner.

It will also be appreciated that because the primary multimedia content is written to restricted data portions of the storage media, it is not overwritten or undesirably affected when the supplemental or secondary data is saved to the unrestricted data portions of the storage media.

### EXAMPLE 2

In the gaming industry it is common for a player to save instances of their game to the computer or console that is being used to play the game, particularly when the game requires a substantial amount of time to complete. Although this can be useful for enabling the player to return to a previous instance in the game, to take advantage of new information, for example, or to simply try again, this practice can also restrict the portability of the game. Accordingly, it can be difficult for the player to transport the saved game instances to another console or computer, where the player wishes to resume playing the game, such as, for example, at a friend's house.

Although certain techniques and devices have been developed that allow saved game instances to be stored on separate portable storage media, this practice can increase the overall cost and maintenance required to play the game, by requiring the user to purchase and keep track of the additional storage media.

According to the present invention, however, the game application can be saved to the restricted data portions of the storage media and the unrestricted portions of the storage media can be reserved to save the corresponding played game instances. Because the game application is written to restricted data portions of the storage media, it is not overwritten or undesirably affected when the game instances are saved to the unrestricted data portions of the storage media.

Software modules provided with the game can also be used to successfully index the saved game instances, such that a player can arbitrarily replace any one or more of the saved game instances at any desired time. It will be appreciated that when only selected game instances are overwritten or added to the unrestricted data portion of the storage media, the computing device being used to play the game can be used to cache all of the data on the unrestricted data portion and to rewrite the unrestricted data portion in the desired manner.

### EXAMPLE 3

Software updates that include such things as patches, drivers, executables, and other supplemental information, are often made available for software applications, including games, after the software has been purchased by a consumer or otherwise packaged for sale. These updates are typically desirable because they can enhance or otherwise improve the application. However, it can be difficult at times for a consumer to find and download the updates, particularly, when the updates are provided though an unreliable Internet or network connection.

The process of finding and downloading updates is even more problematic when the applications have to be reinstalled onto the consumer's computer, such as after a computer failure or when the consumer upgrades their computer. In particular, the consumer has to find the updates all over again and load them onto the computer.

The methods of the present invention can simplify this procedure, however, by enabling the consumer to download the corresponding updates to the unrestricted data portions of the storage media, and without undesirably affecting the related applications. In particular, the applications can be written to restricted data portions that are not overwritten or undesirably affected when the corresponding updates are written to the unrestricted data portions of the storage media. As in the foregoing examples, the cache of the user's computing system can be used to facilitate recording of updates on an incremental basis, and such that the unrestricted portion of the storage media can be overwritten in its entirety every time a new update is saved. In this and the other embodiments of the invention, multiple unrestricted data portions can also be provided to reduce any need for system cache. An index corresponding to the unrestricted data portion, which is separate from the index corresponding to the restricted data portion or a master index corresponding to both sections, can also be revised anytime an update is recorded to the disk.

In the foregoing example corresponding to storing updates, and in subsequent examples corresponding to archiving data, it will be appreciated that the hybrid disks of the present invention can be particularly useful in the field of tax preparation, particularly as pertaining to archiving tax statements and the software used during preparation thereof. The disks can also be useful for storing updates, as described above, thereby overcoming many of the problems described above, corresponding to tax preparation.

### EXAMPLE 4

The present invention can also be useful for completing and reusing forms. In particular, a form or a template can be saved to the restricted data portions of the storage media and the unrestricted portions of the data portion can be reserved for the corresponding form data and other input related to the form or template. In this manner, a template on the combination storage media can be utilized by multiple parties and without requiring the redundant storage of the template on the storage media.

### EXAMPLE 5

In the education industry, the combination storage media of the invention can be used to record primary educational data including lectures, testing materials, and projects to the restricted use data portion of the storage media and while preserving the unrestricted portions of the storage media for corresponding secondary data, such as, but not limited to collaboration, answers to test questions, project enhancements, or other feedback. This secondary data can be written to the storage media without undesirably affecting the primary data and in such a way that a teacher could reuse the disk again and again for different students or in different circumstances.

### EXAMPLE 6

The same can be true in the engineering industry, by enabling a project or base design to be saved to the restricted use data portion in an intended state of preservation, and such that it will not be undesirably affected by any secondary data that is subsequently recorded to the unrestricted data portions of the disk. Accordingly, engineers could independently take the disk and generate or save enhancements or modifications to the project, without actually affecting the project. Thereafter, a supervisor or committee could review and accept or reject the one or more different proposals received and stored in the unrestricted data portions.

Although similar functionality can currently be provided with sophisticated software, the present invention provides a hardware solution that is less susceptible to potential breaches of inherently vulnerable software architectures. The same is true for many of the examples provided herein, especially the following.

### EXAMPLE 7

Another exploit of the inventive hybrid storage media includes limited use applications and, more particularly, limited use applications that have flexible use limitations that can be renewed or otherwise reset to enable subscribed or permissive use that extends beyond the original limitations.

A desired application, for example, can be stored on the restricted use portion of the combination storage media along with one or more rules or use limitations that correspond to the limited use of the application. The use limitations might include, for example, a predetermined number of uses, a predetermined number of people or computing systems that can utilize the application, and so forth.

Tracking information, counters, or other corresponding use limitation data can then be recorded in the unrestricted data portion of the storage media. For example, a counter can track and update how many times a disk has been used. Once the disk has been used a predetermined number of times, the disk will become inoperable because the rules specify as much. In another example, identifying information about a user's computer can be recorded in the unrestricted portion of the storage media, thereafter, the corresponding use limitation rules set forth in the restricted use portion limit future use of the storage media based upon whether the computing system operating the storage media matches the recorded identification information corresponding to the use limitations.

In certain instances, enablement and access to the limited use application can be written, in a fixed manner, to rely on corresponding keys, tokens, or other enabling data that is written to the unrestricted use portions of the storage media along with the other limitation data in an unfixed format. Once the predefined use has expired or been used, according to the rules, the storage media executes a self-contained module that overwrites the enabling keys or tokens, so as to further prevent use of the application.

In another embodiment, the secondary data comprising the tracking information, identification information, counters, and other corresponding use limitation data is reset or otherwise renewed by a third party when the user subscribes for additional use through payment or satisfaction of some predetermined or flexible criteria. In particular, upon satisfaction of a criteria, a third party can transmit, in a secure manner, the corresponding tokens, keys or other enabling data that is written to the unrestricted portions of the storage media, thereby enabling extended or additional use in a controlled manner. Similarly, the third party could simply transmit a script or executable that flexibly causes the counter or other tracking information to be reset or reconfigured to enable additional limited use, and without having to consider or rewrite an entire application. Instead, consideration is only needed for the unrestricted data use portion containing the corresponding tokens, keys or other enabling data.

In the foregoing examples, users can use and renew limited use applications, and without incurring unnecessarily expense and effort in logging into a third party site that would otherwise be commissioned to track the use of the application. It will be appreciated that in this manner, the combination storage media carries the limited use application, as well as the dynamic use tracking information and corresponding authorization to use the disk, thereby providing a hardware solution to traditional software problems.

Although the foregoing example makes reference to rules that are written to the unrestricted use portions of the storage media, it will be appreciated that the rules can also be written to the unrestricted data portions as well. It should also be appreciated that although the secondary data written to the unrestricted data portions can restrict or otherwise prevent access or use of the primary data (e.g., application), that the secondary data does not undesirably affect the primary data. In particular, it is desirable in some circumstances, as described above, that access and use of the primary data is prevented.

### EXAMPLE 8

The inventive combination storage media can also be useful for preserving evidentiary matters. For example, a piece of evidence or other primary data that is intended to remain in a preserved state can be recorded to the restricted use data portion and commentary or other corresponding secondary data can be recorded to the unrestricted use data portion without undesirably affecting of primary evidence.

In one embodiment, for example, a legal document can be written to the restricted use data portion, with or without corresponding signatures of witnesses (e.g., digital signatures nor images of written signatures). Thereafter, codicils or appending documents can be written to the unrestricted data portions of the same storage media, with or without the signatures of witnesses and without destroying the original document. This embodiment would be particularly useful for appending the list of property in a codicil to a will and testament and without having to redraft and re-execute the will and testament.

### EXAMPLE 9

The combination storage media can also be used to integrate and perform security functions, such as, but not limited to authorization, authentication, and verification prior to enabling use of the storage media. In particular, an application or other primary data, such as, but not limited to, a user's personal documents or other materials can be written to restricted and non-restricted use portions of the storage media and in such a way that they can only be accessed upon verifying, authenticating, and/or authorizing a user. To perform such security functionality, computing modules can be written to restricted and/or unrestricted security data portions of the storage media that establish rules for limiting/controlling access to the primary data. In particular, passwords or other security data can be customized and established in the security data portions of the disk that limit access to the primary data.

It will be appreciated that the foregoing examples have been provided to illustrate the utility of a combination storage media having both restricted and unrestricted use data portions. These examples, however, should not be construed as exhaustive.

Some non-limiting examples for using a combination storage media having two different types of restricted data portions will also be provided to further illustrate the utility of the inventive combination storage media. The foregoing methods and examples correspond with the flowchart 600 illustrated in FIG. 6 in which primary data is written to a first restricted use data portion, in an intended state of preservation, (act 610) and in which secondary data is written to a second restricted use data portion, in an intended state of preservation (act 620). Preferably, act 620 is performed without undesirably affecting access or use of the primary data, as generally inferred herein. To the contrary, the second restricted use data portion can actually control access to and use of the primary data, as generally described herein.

The first and second restricted use data portions can comprise any combination of read-only and write formatted memory. In one preferred embodiment, however, the first restricted use data portion comprises read-only memory and the second restricted use data portion comprises either write memory or a different type of read-only memory having different physical properties than the first restricted use data portion.

### EXAMPLE 10

The foregoing combination storage media can be particularly useful for enhancing the security features previously described. For example, a computing security module that prompts a user for passwords, digital signatures, certificates, personal information, or any other security information can be written to the first restricted use data portion, before or after distribution of the storage media. Thereafter, any other data (which is referred to as primary data) that the user wishes to lock up and preserve in the storage media can be written to the second restricted data portion and locked up by the recorded security information.

Accordingly, access to the primary data thereby effectively controlled/limited by the security module and corresponding security information that is written to the first restricted data portion, such that access to the primary data is only permitted upon satisfying the security criteria established by the security module and based upon the user input security information. During an attempt to access the primary data, for example, the security module can prompt or query for appropriate security information which will be verified by the stored security information prior to granting the desired access.

In embodiments where the security module is disposed on the disk during manufacture, and prior to commercial sale, the security module can be configured to prompt the user for security information (e.g., passwords, PINS, computing system identifiers, etc.) that will be written to a separate restricted or unrestricted security data portion and used to control access to any quantity of primary data written to any number of restricted and/or unrestricted data portions. During attempted use, the security module can prompt a user and/or computing system for the corresponding security information used to verify/authenticate/authorize use. If the security information obtained from the user and/or computing system matches the stored security information, use may be granted.

To prevent an unauthorized user from accessing the stored security information, the security information can be encrypted by the security module during the storage process and decrypted during the comparison process. It will be appreciated that various other means for securing and preventing unauthorized access to the security information and primary data, as described by the foregoing can also be employed using the hybrid storage media, and without having to rely on a remote third party. In essence the hybrid storage media can be configured in such a way that security information that is stored in one or more restricted and/or unrestricted data portions controls access to primary data in one or more different restricted and/or unrestricted data portions. The data portions may be distinguished by physical properties (e.g., read-only vs. read/write) and/or by data portions having distinct indexes.

### EXAMPLE 11

In another embodiment, the security information can also be written to an unrestricted data portion instead of a restricted data portion, thereby enabling a user to update, alter, or otherwise modify the security information. This embodiment can be particularly useful when the security information corresponds to computing system identifiers that may change. In other words, if a disk is restricted for use to a particular computing system and the identifiers of that computing system change, it may be necessary to change the stored security information on the disk to enable access to the disk and corresponding primary data.

### EXAMPLE 12

In yet other embodiments, the combination storage media can be used to deter copyright infringement. For example, primary data can be written to the storage media in either the restricted or unrestricted use data portions and with enabling data. Modules that cause the enabling data or the primary data to be overwritten upon detecting that the disk has been copied can then be stored on the restricted use data portions. Accordingly, upon having the disk copied, as detected by the modules, in cooperation with the playing device, the enabling data or the primary data are overwritten, thereby rendering the disk inoperative. Although the primary data is overwritten, it will be appreciated that the primary data still has not been undesirably altered by the secondary data. In particular, the desired result of disabling the primary data was accomplished.

Coloring Scheme Identification

Although not necessary, the different data portions can also be manufactured in such a way as to visually indicate what types of data portions exist on a disk. For example, in order to enable a consumer to quickly distinguish between the various types of hybrid disks, the different types of data portions can be colored differently prior to manufacture. It will be appreciated that coloring the data portions differently is one way to provide different physical properties to the different data portions.

In one embodiment, the restricted data portions are colored red and the unrestricted data portions are colored green. It will be appreciated however, that other color schemes can also be used. For example, different types of restricted data portions (e.g., write and read-only) can also be colored differently, as desired.

In other embodiments, data portions having similar storage configurations (e.g., read-only, write, read/write) can also be colored differently to visually indicate to the user how many different data portions are already present on the disk.

In yet other embodiments, the colored data portions can also be configured to dynamically change in response to writing/erasing the data stored thereon. For example, although different coloring schemes can be used, a first color such as green can be used to indicate the portions of the disk that are blank or writable, whereas another color can be used to indicate the portions of the disk that have already been written to.

When a disk contains multiple data portions and/or when special software is used to invoke multi-session recording, this technique of intentionally coloring the disk can be useful to visually indicate how much of the disk capacity is being used and how much is still available. According to this embodiment, the color of the disk will progressively change, as the data is written to it, and in such a way as to indicate what portions of the disk can still be written to.

It will be appreciated that the color(s) used to distinguish the portions of the disk that have been written to can also vary depending on whether the data is written to restricted data portions or unrestricted data portions. For example, the color red can be used to indicate the data cannot be overwritten, whereas the color yellow can indicate that data is written to rewritable portions and that it can be overwritten. Obviously, different color schemes can be used as well.

The foregoing example can be particularly helpful in reducing the time and effort it can take for a user to determine whether a disk is blank, filled or has any capacity for storing additional data. Accordingly, although the foregoing coloring techniques are particularly useful for the hybrid storage media, it will be appreciated that these same coloring techniques can also be useful for traditional disks having only a single type of storage configuration (e.g., write and rewrite).

Those of skill in the art of photo-sensitive and thermo-sensitive dyes will realize that there are various different photo-sensitive and thermo-sensitive dyes that can be used to intentionally create or cause the color changes described above in response to or during the writing, erasing and rewriting processes that are typically used with optical disks. In particular, coloring dyes can be applied to the disks to effect the changes in color when heat and/or particular light spectrums are applied during the writing, erasing and rewriting processes. These coloring dyes can be applied to the disks within integrated combination layers with the dyes described above in reference to FIGS. 2 and 3, or in separate layers.

### SUMMARY

In summary, the hybrid storage media of the present invention provides a hardware solution to many problems that have been inadequately resolved by inherently vulnerable software solutions. It will be appreciated that although the invention has been primarily described with reference to optical disks, that the invention also extends to other types of storage media as well.

Likewise, it will be appreciated that any of the foregoing examples and applications of the inventive storage media can also be combined. As a matter of example, the combination storage media in example 10, having two restricted use data portions, can also be combined with any of the combination storage media identified in examples 1-9, so as to extend the security features described in example 10 to the other examples as well. Accordingly, to enable such a combination, the storage media can include at least two restricted use data portions and at least one unrestricted use data portion.

It will be appreciated that the potential uses for the inventive combination storage media are very diverse and extensive, even at this present time, as described above. It is also anticipated that the utility of the hybrid storage media will become even more apparent and practical as the storage capacities of optic, magnetic and solid state media continue to improve and as computing devices become more sophisticated at reading the various formats of the storage media.

Accordingly, even though certain examples and embodiments have been provided with regard to potential methods of using the combination storage media, it will be appreciated that the methods of using the inventive storage media, as shown described herein (e.g., FIGS. 5 and 6), extend beyond the specific examples that have been provided.

Computing Environments

It will be appreciated by those of skill in the art that the methods of the invention can be practiced in various computing systems and network computing environments including personal computers, hand-held devices, multi-processor systems, microprocessor-based or programmable consumer electronics, network PCs, minicomputers, mainframe computers, TV set-top boxes, DVD players, CD players, and the like.

The methods of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

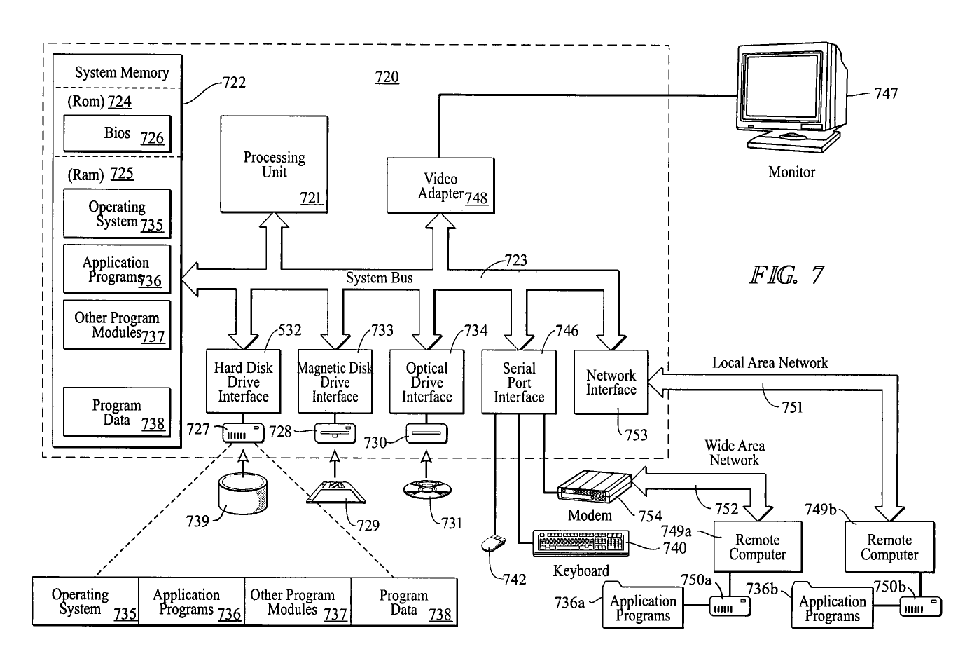

With reference to FIG. 7, an exemplary system that can be used for implementing certain methods of the invention includes a general purpose computing device in the form of a conventional computer 720, including a processing unit 721, a system memory 722, and a system bus 723 that couples various system components including the system memory 722 to the processing unit 721. The system bus 723 may be any of several types of bus structures including a memory bus or memory controller, a peripheral bus, and a local bus using any of a variety of bus architectures. The system memory includes read-only memory (ROM) 724 and random access memory (RAM) 725. A basic input/output system (BIOS) 726, containing the basic routines that help transfer information between elements within the computer 720, such as during start-up, may be stored in ROM 724.

The computer 720 may also include a magnetic hard disk drive 727 for reading from and writing to a magnetic hard disk 739, a magnetic disk drive 728 for reading from or writing to a removable magnetic disk 729, and an optical disk drive 730 for reading from or writing to removable optical disk 731 such as a CD-ROM, DVD-ROM or other optical media. The magnetic hard disk drive 727, magnetic disk drive 728, and optical disk drive 730 are connected to the system bus 723 by a hard disk drive interface 732, a magnetic disk drive-interface 733, and an optical drive interface 734, respectively. The drives and their associated computer-readable media provide nonvolatile storage of computer-executable instructions, data structures, program modules and other data for the computer 720. Although the exemplary environment described herein employs a magnetic hard disk 739, a removable magnetic disk 729 and a removable optical disk 731, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 739, magnetic disk 729, optical disk 731, ROM 724 or RAM 725, including an operating system 735, one or more application programs 736, other program modules 737, and program data 738. A user may enter commands and information into the computer 720 through keyboard 740, pointing device 742, or other input devices (not shown), such as a microphone, joy stick, game pad, satellite dish, scanner, or the like. These and other input devices are often connected to the processing unit 721 through a serial port interface 746 coupled to system bus 723. Alternatively, the input devices may be connected by other interfaces, such as a parallel port, a game port or a universal serial bus (USB). A monitor 747 or another display device is also connected to system bus 723 via an interface, such as video adapter 748. In addition to the monitor, personal computers typically include other peripheral output devices (not shown), such as speakers and printers.

The computer 720 may operate in a networked environment using logical connections to one or more remote computers, such as remote computers 749a and 749b. Remote computers 749a and 749b may each be another personal computer, a server, a router, a network PC, a peer device or other common network node, and typically include many or all of the elements described above relative to the computer 720, although only memory storage devices 750a and 750b and their associated application programs 736a and 736b have been illustrated in FIG. 7. The logical connections depicted in FIG. 7 include a local area network (LAN) 751 and a wide area network (WAN) 752 that are presented here by way of example and not limitation. Such networking environments are commonplace in office-wide or enterprise-wide computer networks, intranets and the Internet.

When used in a LAN networking environment, the computer 720 is connected to the local network 751 through a network interface or adapter 753. When used in a WAN networking environment, the computer 720 may include a modem 754, a wireless link, or other means for establishing communications over the wide area network 752, such as the Internet. The modem 754, which may be internal or external, is connected to the system bus 723 via the serial port interface 746. In a networked environment, program modules depicted relative to the computer 720, or portions thereof, may be stored in the remote memory storage device. It will be appreciated that the network connections shown are exemplary and other means of establishing communications over wide area network 752 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A hybrid optical storage media having at least two distinct data portions that are configured to store data, the hybrid optical storage media comprising:
a restricted data portion that is physically configured to store data in an intended state of preservation, wherein the restricted data portion is manufactured as at least one of a write and a read-only data portion that is configured to prevent data written to the restricted data portion from being overwritten; and
an unrestricted data portion that is physically configured to store data in rewritable format, such that it can be overwritten.

2. A hybrid optical storage media as recited in claim 1, wherein the restricted and unrestricted data portions are disposed on a single side of the hybrid optical storage media.

3. A hybrid optical storage media as recited in claim 2, wherein the restricted data portion and the unrestricted data portion each have a separate index.

4. A hybrid optical storage media as recited in claim 1, further including at least one of an additional restricted data portion and an unrestricted data portion and such that the hybrid optical storage media includes at least three physically distinct data portions.

5. A hybrid optical storage media as recited in claim 1, wherein data stored in the restricted data portion controls access to data stored in the unrestricted data portion.

6. A hybrid optical storage media as recited in claim 1, wherein data stored in the restricted data portion comprises primary data and wherein the unrestricted data portion comprises secondary data that corresponds to the primary data.

7. A hybrid optical storage media as recited in claim 1, wherein the restricted data portion and the unrestricted data portion have physically distinct properties.

8. A method for using a hybrid optical storage media having at least a restricted data portion and an unrestricted data portion that are each configured to store data, the method comprising:
writing primary data to a restricted data portion of the hybrid optical storage media in an intended state of preservation, wherein the restricted data portion is manufactured as at least one of a write and a read-only data portion that is configured to prevent the primary data from being overwritten; and
writing secondary data to an unrestricted data portion of the hybrid optical storage media in a state that enables the secondary data to be overwritten.

9. A method as recited in claim 8, wherein the secondary data corresponds directly to the primary data.

10. A method as recited in claim 9, wherein the primary data includes an application and the secondary data includes an update corresponding to the application.

11. A method as recited in claim 8, wherein the secondary data controls at least one of access to the primary data and use of the primary data.

12. A method as recited in claim 11, wherein the secondary data is used to perform at least one of authentication, verification and authorization prior to enabling access to the primary data.

13. A method as recited in claim 8, wherein the method further includes modifying the secondary data in the unrestricted data portion and without undesirably affecting the primary data.

14. A method as recited in claim 8, wherein the restricted data portion and the unrestricted data portion comprise different physical properties.

15. A method as recited in claim 14, wherein the different physical properties comprise different colors, such that the restricted and unrestricted data portions are colored differently.

16. A method as recited in claim 8, wherein the restricted data portion and the unrestricted data portion are colored and wherein the method further includes intentionally modifying the coloring of either the restricted and unrestricted data portions during writing.

17. A hybrid optical storage media having at least two physically distinct data portions that are configured to store data, the hybrid optical storage media comprising:
a first restricted data portion that is physically configured to store data in an intended state of preservation, wherein the first restricted data portion is manufactured as at least one of write and read-only data portion configured to prevent data written to the first restricted data portion from being overwritten; and
a second restricted data portion that is physically configured to store data in an intended state of preservation, wherein the second restricted data portion is manufactured as at least one of write and read-only data portion configured to prevent data written to the second restricted data portion from being overwritten.

18. A hybrid optical storage media as recited in claim 17, wherein the first and second restricted data portions are disposed on a single side of the hybrid optical storage media.

19. A hybrid optical storage media as recited in claim 17, wherein the different physical properties include different colors, such that the first and second restricted data portions are colored differently.

20. A hybrid optical storage media as recited in claim 17, wherein data written to the first restricted data portion controls access to the second restricted data portion.
